(19) United States
(12) Patent Application Publication
(10) Pub. No.: US 2016/0034921 A1
(43) Pub. Date: Feb. 4, 2016

(54) REASSIGNING A BUSINESS HIERARCHY OF ROLES ASSOCIATED WITH AN OPPORTUNITY IN A SOCIAL CUSTOMER RELATIONSHIP MANAGEMENT (CRM) SYSTEM

(71) Applicant: International Business Machines Corporation, Armonk, NY (US)

(72) Inventors: Jorge A. Arroyo, Carmel, IN (US); Stephen P. Kruger, Dublin (IE); Patrick J. O'Sullivan, Dublin (IE); Luciano Silva, Apex, NC (US)

(21) Appl. No.: 14/449,973

(22) Filed: Aug. 1, 2014

(51) Int. Cl. G06Q 30/02; G06F 17/30

(52) U.S. Cl. CPC G06Q 30/0201; G06F 17/30997

(57) ABSTRACT

Reassigning a business hierarchy of roles associated with an opportunity in a social customer relationship management (CRM) system includes receiving modifications, the modifications representing an adjustment to a business hierarchy of roles, identifying, in a social CRM system, an opportunity associated with the business hierarchy of roles, and reassigning, based on the modifications, the opportunity associated with the business hierarchy of roles, in which reassigning, based on the modifications, the business hierarchy of roles associated with the opportunity includes adding or deleting a member or a department from the business hierarchy of roles.

### BACKGROUND

The present invention relates to reassigning a business hierarchy of roles associated with an opportunity, and more specifically, to reassigning the business hierarchy of roles associated with the opportunity in a social customer relationship management (CRM) system.

A social CRM system uses techniques and methods to gather, organize, automate, and synchronize sales, for marketing, customer service, and technical support. This information is stored in the social CRM system's memory. Further, this information is retrieved from the social CRM system's memory and analyzed to allow a company to better target various customers.

### BRIEF SUMMARY

A method for reassigning a business hierarchy of roles associated with an opportunity in a social customer relationship management (CRM) system includes receiving modifications, the modifications representing an adjustment to a business hierarchy of roles, identifying, in a social CRM system, an opportunity associated with the business hierarchy of roles, and reassigning, based on the modifications, the opportunity associated with the business hierarchy of roles, in which reassigning, based on the modifications, the business hierarchy of roles associated with the opportunity includes adding or deleting a member or a department from the business hierarchy of roles.

A system for reassigning a business hierarchy of roles associated with an opportunity in a social CRM system, includes a monitoring engine to monitor a social CRM system to determine modifications made to a business hierarchy of roles, a receiving engine to receive the modifications, the modifications representing an adjustment to the business hierarchy of roles, an identifying engine to identify, in the social CRM system, an opportunity associated with the business hierarchy of roles, and a reassigning engine to reassign, based on the modifications, the opportunity associated with the business hierarchy of roles, in which the reassigning engine reassigns, based on the modifications, the business hierarchy of roles associated with the opportunity by adding or deleting a member or a department from the business hierarchy of roles.

A computer program product includes a computer readable storage medium, the computer readable storage medium having computer readable program code embodied therewith. The computer readable program code having computer readable program code to monitor a social CRM system to determine modifications made to a business hierarchy of roles, identify, in the social CRM system, an opportunity associated with the business hierarchy of roles, and reassign, based on the modifications, the opportunity associated with the business hierarchy of roles, in which the computer program product reassigns, based on the modifications, the business hierarchy of roles associated with the opportunity by adding or deleting a member or a department from the business hierarchy of roles.

### BRIEF DESCRIPTION OF THE SEVERAL VIEWS OF THE DRAWINGS

The accompanying drawings illustrate various examples of the principles described herein and are a part of the specification. The examples do not limit the scope of the claims.

FIG. 1 is a diagram of an example of a system for reassigning a business hierarchy of roles associated with an opportunity in a social customer relationship management (CRM) system, according to one example of principles described herein.

FIG. 2 is a diagram of an example of a system for reassigning a business hierarchy of roles associated with an opportunity in a social CRM system, according to one example of principles described herein.

FIG. 3 is a flowchart of an example of a method for reassigning a business hierarchy of roles associated with an opportunity in a social CRM system, according to one example of principles described herein.

FIG. 4 is a flowchart of an example of a method for reassigning a business hierarchy of roles associated with an opportunity in a social CRM system, according to one example of principles described herein.

FIG. 5 is a diagram of an example of a reassigning system, according to the principles described herein.

FIG. 6 is a diagram of an example of a reassigning system, according to the principles described herein.

Throughout the drawings, identical reference numbers designate similar, but not necessarily identical, elements.

### DETAILED DESCRIPTION

The present specification describes a method and system for reassigning a business hierarchy of roles associated with an opportunity in a social customer relationship management (CRM) system, such that the business hierarchy of roles associated with the opportunity is reassigned automatically.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, the social CRM system uses techniques and methods to organize, automate, and synchronize sales, for marketing, customer service, and technical support. This information that the social CRM system gathers is stored in the social CRM system's memory. Further, this information may be categorized as opportunities in the social CRM system's memory. A user associated with a company may view the opportunities gather by the social CRM system to allow the company to better target various customers.

Often, modifications are made to this information stored in the social CRM system. For example, customer accounts merge, split, or change geographies. Further, products being sold is consolidated, split, or become discontinued. As a result, the opportunities in the social CRM system needs to be reassigned based on these modifications. Often, the opportunities in the social CRM system are manually reassigned based on these modifications. Manually reassigning the opportunities in the social CRM system can result in human error. Further, manually reassigning the opportunities in the social CRM system can be a burdensome task when there are thousands of opportunities in a social CRM system.

The principles described herein include a system and a method for reassigning a business hierarchy of roles associated with an opportunity in a social CRM system. Such a system and method includes receiving modifications, the modifications representing an adjustment to a business hierarchy of roles, identifying, in a social CRM system, an opportunity associated with the business hierarchy of roles, and reassigning, based on the modifications, the opportunity associated with the business hierarchy of roles, in which reassigning, based on the modifications, the business hierarchy of roles associated with the opportunity includes adding or deleting a member or a department from the business hierarchy of roles. Such a method and system allows a transferal of business hierarchy of roles, associated with opportunities, between businesses by abstracting the members of the opportunities by their role and assigning appropriate members matching specific profiles to another opportunity. As a result, the business hierarchy of roles associated with the opportunity is reassigned automatically.

In the specification and appended claims, the term “modifications” is meant to be understood broadly as an adjustment to a business hierarchy of roles that is associated with an opportunity. In one example, a modification may be adding or deleting a member and/or a department from a business hierarchy of roles.

In the specification and appended claims, the term “business hierarchy of roles” is meant to be understood broadly as a relationship between members and/or a department associated with an opportunity. For example, a member, such as a project architect may be the lead project architect for opportunity A. As a result, the business hierarchy of roles for opportunity A indicates that the member is lead project architect.

In the specification and appended claims, the term “opportunities” is meant to be understood broadly as a complex record structure in a social CRM system, in which each of the opportunities captures a number of fields of metadata. In one example, the opportunities may include a business's sales and/or interaction with current customers, future customers, or combinations thereof.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

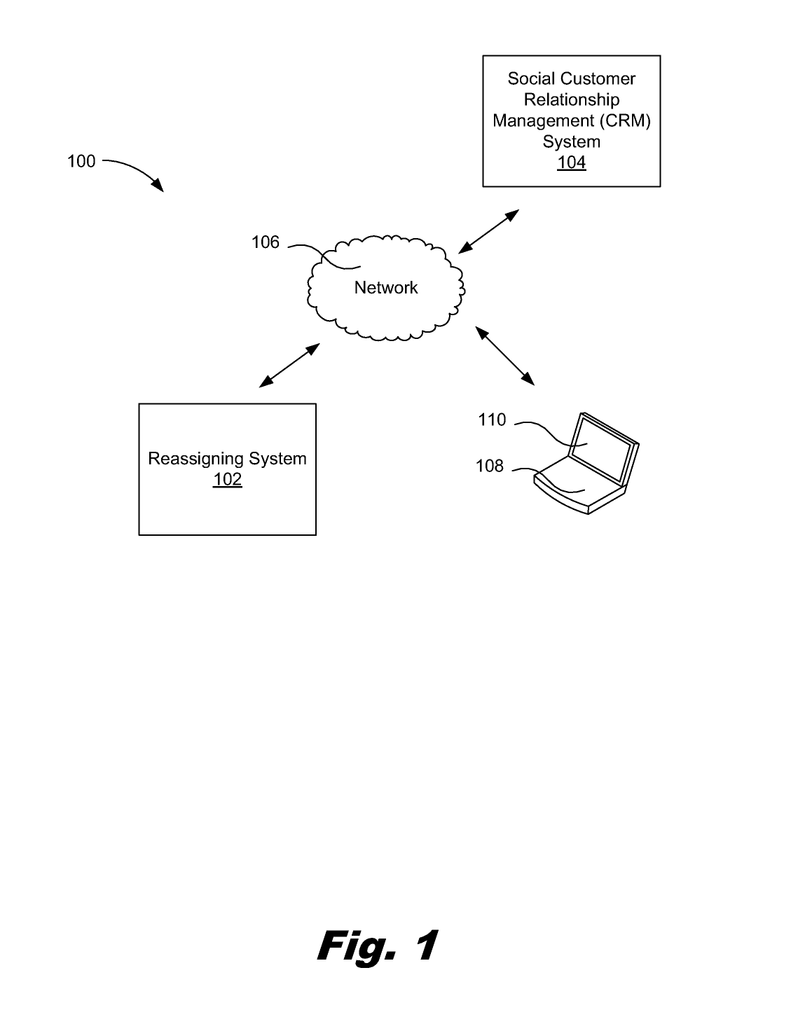

FIG. 1 is a diagram of an example of a system for reassigning a business hierarchy of roles associated with an opportunity in a social CRM system, according to one example of principles described herein. As will be described below, a reassigning system is in communication with a network to receive modifications, the modifications representing an adjustment to a business hierarchy of roles. The reassigning system further identifies, in a social CRM system, an opportunity associated with the business hierarchy of roles. Further, the reassigning system reassigns, based on the modifications, the opportunity associated with the business hierarchy of roles, in which reassigning, based on the modifications, the business hierarchy of roles associated with the opportunity includes adding or deleting a member or a department from the business hierarchy of roles.

As illustrated in FIG. 1, the system (100) includes a social CRM system (104). As noted above, the social CRM system (104) uses techniques and methods to organize, automate, and synchronize sales, for marketing, customer service, and technical support. This information that the social CRM system (104) gathers is stored in the social CRM system's memory. Further, this information may be categorized as opportunities in the social CRM system's memory. A user associated with a company may view the opportunities gather by the social CRM system (104) to allow the company to better target various customers.

As illustrated in FIG. 1, the system (100) includes a reassigning system (102). The reassigning system (102) receives modifications, the modifications representing an adjustment to a business hierarchy of roles. In one example, the modifications may be made by a user via a user device (108).

Further, the reassigning system (102) identifies, in the social CRM system (104), an opportunity associated with the business hierarchy of roles. In one example, several opportunities may be identified.

The reassigning system (102) further reassigns, based on the modifications, the opportunity associated with the business hierarchy of roles. In one example, reassigning, based on the modifications, the business hierarchy of roles associated with the opportunity includes adding or deleting a member or a department from the business hierarchy of roles. As a result, such a reassigning system (102) allows a transferal of business hierarchy of roles, associated with opportunities, between businesses by abstracting the members of the opportunities by their role and assigning appropriate members matching specific profiles to another opportunity. As a result, the business hierarchy of roles associated with the opportunity is reassigned automatically. More information about the reassigning system (102) will be described in other parts of this specification.

While this example has been described with reference to the reassigning system being located over the network, the reassigning system may be located in any appropriate location. For example, the reassigning system may be located in a user device, a database, a social CRM system, other locations, or combinations thereof.

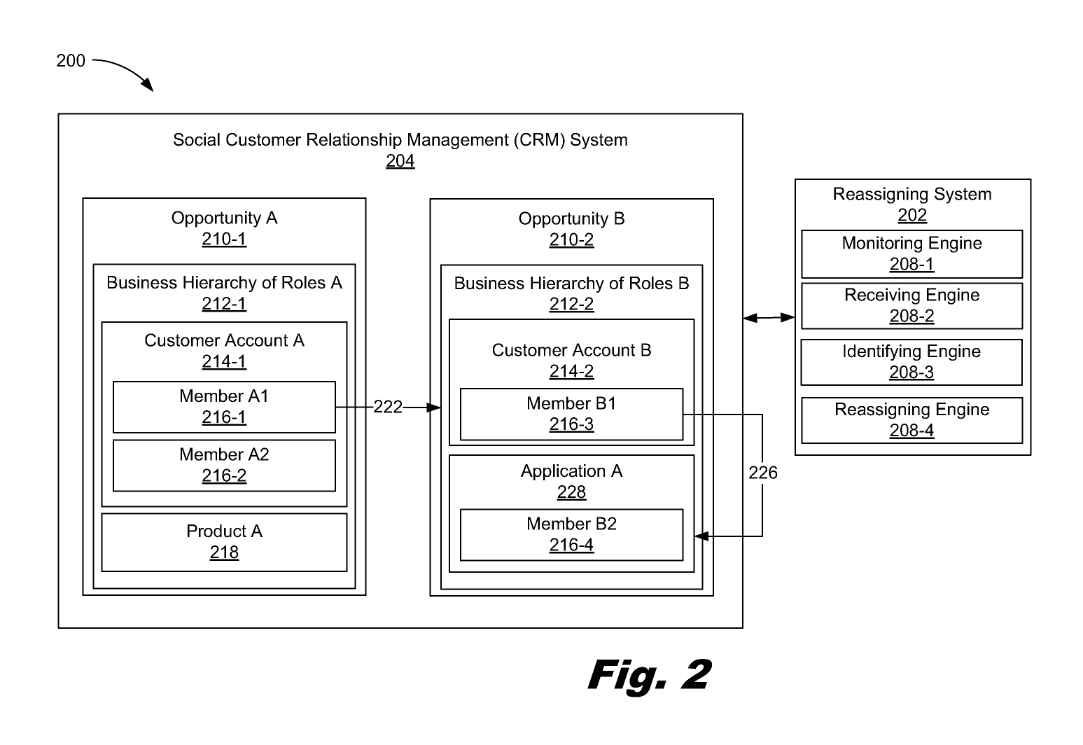

FIG. 2 is a diagram of an example of a system reassigning a business hierarchy of roles associated with an opportunity in a social CRM system, according to one example of principles described herein. As mentioned above, a reassigning system is in communication with a network to receive modifications, the modifications representing an adjustment to a business hierarchy of roles. The reassigning system further identifies, in a social CRM system, an opportunity associated with the business hierarchy of roles. Further, the reassigning system reassigns, based on the modifications, the opportunity associated with the business hierarchy of roles, in which reassigning, based on the modifications, the business hierarchy of roles associated with the opportunity includes adding or deleting a member or a department from the business hierarchy of roles.

As illustrated in FIG. 2, the system (200) includes a social CRM system (204). In one example, the social CRM system (204) is used as a model for managing a business's interactions with current and future customers. The social CRM system (204) uses techniques and methods to organize, automate, and synchronize sales, for marketing, customer service, and technical support. In one example the social CRM system (204) may monitor sources such as social media sources. In this example, the social CRM system's strategy is based around customer engagement and interactions, with transactions being a byproduct. In this example, the social CRM system (204) may use a philosophy and a business strategy, supported by a technology platform, business rules, workflow, processes and social characteristics, designed to engage the customer in a collaborative conversation in order to provide mutually beneficial value in a trusted and transparent business environment. Further, the social CRM system (204) includes applications in marketing, customer service and sales, including peer-to-peer customer support, idea management, market research, product launch, brand reputation management.

In this example, the social CRM system (204) is a back-end process and system for managing customer relationships and data in an efficient and process-centric way. The social CRM system (204) is able to understand the business's challenges that are to be solved and then solve the business's challenges. Further, the social CRM system (204) may be one component of developing a social or collaborative business, both internally and externally. As a result, the social CRM system (204) may provide a richer and more accurate reassignment of business hierarchy of roles associated with an opportunity than a traditional CRM system because of the information the social CRM system (204) gathers.

As illustrated in FIG. 2, the social CRM system (204) includes a number of opportunities (210). For example, the social CRM system (204) includes opportunity A (210-1) and opportunity B (210-2). Further, the opportunities (210) include a business hierarchy of roles (212). For example, opportunity A (210-1) includes business hierarchy of roles A (212-1) and opportunity B (210-2) includes business hierarchy of roles B (212-2).

In this example, business hierarchy of roles A (212-1) includes customer account A (214-1) and product A (218-1). Further customer account A (214-1) may include member Al (216-1) and member A2 (216-2). Further, business hierarchy of roles B (212-2) includes customer account B (214-2) and application A (228). Further customer account B (214-2) may include member B1 (216-3) and application A (228) may include member B2 (216-4). As will be described below, modifications may be made to the business hierarchy of roles (212).

As illustrated in FIG. 2, the system (200) includes a reassigning system (202). In one example, the reassigning system (202) includes a monitoring engine (208-1), a receiving engine (208-2), an identifying engine (208-3), and a reassigning engine (208-4). The engines (208) refer to a combination of hardware and program instructions to perform a designated function. Each of the engines (208) may include a processor and memory. The program instructions are stored in the memory and cause the processor to execute the designated function of the engine.

As mentioned above, the reassigning system (202) includes a monitoring engine (208-1). In one example, the monitoring engine (208-1) monitors the social CRM system (204) to determine modifications made to the business hierarchy of roles (212).

As illustrated, the reassigning system (202) includes receiving engine (208-2). The receiving engine (208-2) receives the modifications. As mentioned above, the modifications represent adjustments made to a business hierarchy of roles. In one example, the modifications may include merging, splitting, changing a geography, reassigning, or combinations thereof of the customer accounts (214) associated with the business hierarchy of roles (212). In another example, the modifications may include selling, discontinuing, consolidating, or combinations thereof of product A (218) associated with the business hierarchy of roles (212).

The reassigning system (202) further includes an identifying engine (208-3) to identify, in the social CRM system (204), the opportunity (210) associated with the business hierarchy of roles (212). In one example, the opportunity (210) represents a complex record structure in the social CRM system (204) and each of the opportunities is associated with a number of fields of the metadata. In this example, the metadata may be the customer accounts (214), the members (216), product A (218), other metadata, or combinations thereof.

As mentioned above, the reassigning system (202) further includes a reassigning engine (208-4). The reassigning engine (208-4) reassigns, based on the modifications, the opportunity (210) associated with the business hierarchy of roles (212). In one example, reassigning, based on the modifications, the business hierarchy of roles (210) associated with the opportunity (212) includes adding or deleting a member (216) or a department from the business hierarchy of roles (212). For example, member Al (216-1) may be added via the reassigning engine (208-4) to business hierarchy of roles B (210-2) as illustrated by arrow 222. As a result, member Al (216-1) is deleted from business hierarchy of roles A (210-1) and added to business hierarchy of roles B (210-2).

In another example, reassigning, based on the modifications, the business hierarchy of roles (210) associated with the opportunity (212) includes reassigning members of applications associated with the business hierarchy of roles. For example, member B1 (216-3) may no longer be associated with customer account B (214-2). In this example, a modification may indicate that member B1 (216-3) is to be reassigned via the reassigning engine (208-4) to application A (228) as indicated by arrow 226.

In another example, reassigning, based on the modifications, the business hierarchy of roles (210) associated with the opportunity (212) includes reassigning features, permissions, or combinations thereof for the applications (228) associated with the business hierarchy of roles (210). For example, application A (228) may include a set of permissions and features that are available for members assigned to application A (228). As a result, if member A1 (216-1) is reassigned to application A (228), the set of permissions and features will be available to member A1 (216-1).

An overall example will now be explained with reference to FIG. 2. In one example, member A2 (216-2) needs to be removed from opportunity A (210-1) and added to opportunity B (210-2) due to a horizontal reassignment in client responsibilities. In this example, member A2 (216-2) may be an architect. Further, a replacement for member A2 (216-2) is not yet identified.

The reassigning system (202) has access to all the social CRM artifact memberships of member A2 (216-2), and uses this to build a skills profile listing areas of competency. The reassigning system (202) may accomplish this by identifying commons products and technologies used in the opportunity A (210-1), identifying common themes in the clients that opportunity A (210-1) belong to. For example, using focus areas for clients for retail, building, among others. The reassigning system (202) may accomplish this by further identifying a significance by averaging a financial value of all this members associated with opportunity A (210-1).

This information can then be used to find similar matches of potential replacements by listing other members that are architects and ordering the results based on similarities in skill sets and technology experiences. The reassigning system (202) may further refine the results by showing the relative workload of these proposed replacements and who may or may not be available for the additional workload. Since the reassigning system (202) has the address of the client associated with the target opportunity, the reassigning system (202) can fine tune the ordered list of potential replacements by geographical adjacency.

The replacement member can be selected manually if needed, otherwise an automated decision could be made on pre-determined criteria set by weighting the rules of the reassigning system (202) using any of the variables described above.

Once the replacement is identified, for example member B1 (216-3), the reassignment can be initiated via the reassigning system (202). In one example, the reassigning system (202) duplicates all the social CRM artifacts and associated social network memberships found for member Al (216-1) and grants them to member B1 (216-3). For example, the reassigning system (202) rebuilds an instant message (IM) contact lists based on contact lists of member A1 (216-1) which intersect with memberships of the social CRM artifact being transferred and adds them to the IM contact list of member B1 (216-3).

Further, external systems that are used as parallel vehicles for group collaborative effort around CRM artifacts also have clear associations with CRM artifacts and their artifacts can be reassigned accordingly. For some artifacts, such as files, a member may prefer to not move the ownership, but duplicate the artifacts in question. As a result, the artifact does not incur data loss as a result of the transfer. Community memberships and ownerships of member A1 (216-1) can be added or transferred to member B1 (216-3), and depending on the exit strategy of member A1 (216-1), the reassigning system (202) might decide to keep the original memberships intact until such time as the upskilling and knowledge transfer is appropriately handled.

As a result, the reassigning system (202) takes into account not just the hierarchy relationship but also the skills and behaviors from members in the organization in order to make the reassignment. So when a member, such as an architect, is reassigned to another territory, the reassigning system (202) does not just pick the next architect in the business hierarchy of roles associated with the opportunity to make the reassignment. The reassigning system (202) looks at the social data such as skills, industry expertise, familiarity with a client, in order to make the reassignment. Further, merging the hierarchical organization structure and the social data yields a more accurate assignment for business success.

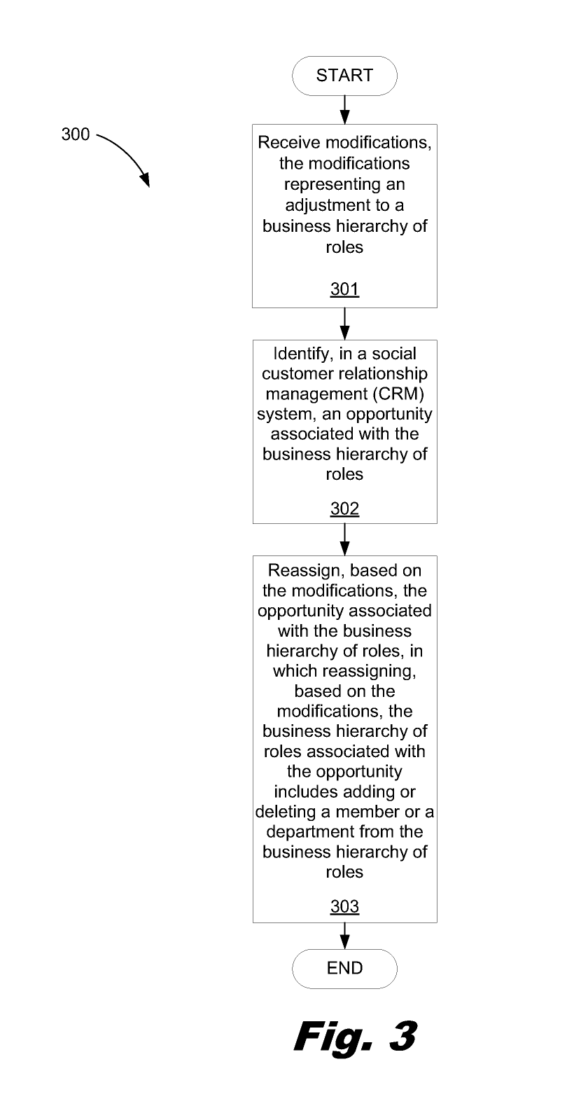

FIG. 3 is a flowchart of an example of a method for reassigning a business hierarchy of roles associated with an opportunity in a social CRM system, according to one example of principles described herein. In one example, the method (300) may be executed by the reassigning system (100) of FIG. 1. In other examples, the method (300) may be executed by other systems (i.e. system 200, system 500, and system 600). In this example, the method (300) includes receiving (301) modifications, the modifications representing an adjustment to a business hierarchy of roles, identifying (302), in a social CRM system, an opportunity associated with the business hierarchy of roles, and reassigning (303), based on the modifications, the opportunity associated with the business hierarchy of roles, in which reassigning, based on the modifications, the business hierarchy of roles associated with the opportunity includes adding or deleting a member or a department from the business hierarchy of roles.

As mentioned above, the method (300) includes receiving (301) modifications, the modifications representing an adjustment to a business hierarchy of roles. As described above, the modifications may further include merging, splitting, changing a geography, reassigning, or combinations thereof of customer accounts associated with the business hierarchy of roles. In another example, the modifications further include selling, discontinuing, consolidating, or combinations thereof of products associated with the business hierarchy of roles.

As mentioned above, the method (300) includes identifying (302), in a social CRM system, an opportunity associated with the business hierarchy of roles. As mentioned above, the opportunities represent a complex record structure in the social CRM system and each of the opportunities is associated with a number of fields of the metadata. In one example, the fields of the metadata may include the business hierarchy of roles. As a result, an opportunity associated with the business hierarchy of roles may be identified by the number of fields of the metadata.

As mentioned above, the method (300) includes reassigning (303), based on the modifications, the opportunity associated with the business hierarchy of roles. In one example, reassigning, based on the modifications, the business hierarchy of roles associated with the opportunity includes adding or deleting a member or a department from the business hierarchy of roles. In this example, adding a member or a department to an opportunity in a social CRM system, the method (300) takes into account a number of vertical and horizontal applications. Each of the applications has their own access and authentication sub-systems, relational data bases, access control lists, and many integrated sub-systems to allow the user access to all the artifacts associated with the opportunity.

Further, reassigning, based on the modifications, the business hierarchy of roles associated with the opportunity further includes adjusting features, permissions, or combinations thereof for the applications associated with the business hierarchy of roles. This allows the propagation of the associated permissions across the social CRM system for that social CRM artifact, such as a client or opportunity. Further the facilitation by each application in implementing the change in cognizance of the request in an end-end automated solution driven from one place where that place would not necessarily represent any one stop shop. For example, a user can add another user to a social CRM graph from any part of the social CRM system and the social CRM system and method takes care of the detail. Further, reassigning, based on the modifications, the business hierarchy of roles associated with the opportunity further includes reassigning members for applications associated with the business hierarchy of roles.

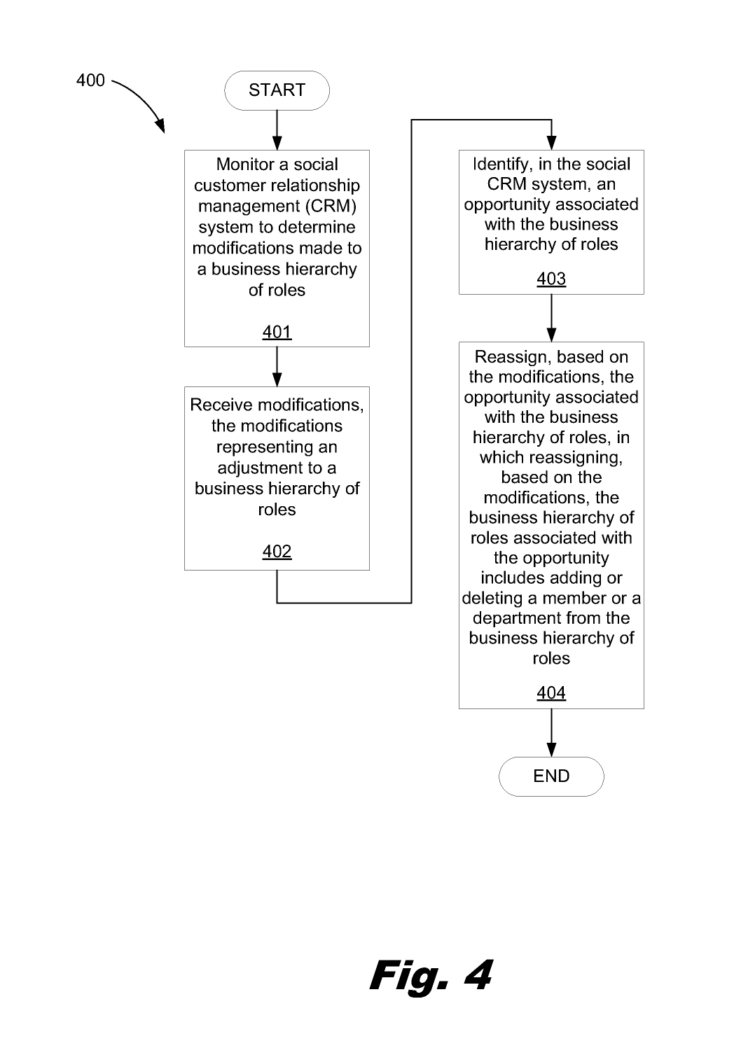

FIG. 4 is a flowchart of an example of a method for reassigning a business hierarchy of roles associated with an opportunity in a social CRM system, according to one example of principles described herein. In one example, the method (400) may be executed by the reassigning system (100) of FIG. 1. In other examples, the method (400) may be executed by other systems (i.e. system 200, system 500, and system 600). In this example, the method (400) includes monitoring (401) a social CRM system to determine modifications made to the business hierarchy of roles, receiving (402) modifications, the modifications representing an adjustment to a business hierarchy of roles, identifying (403), in a social CRM system, an opportunity associated with the business hierarchy of roles, and reassigning (404), based on the modifications, the opportunity associated with the business hierarchy of roles, in which reassigning, based on the modifications, the business hierarchy of roles associated with the opportunity includes adding or deleting a member or a department from the business hierarchy of roles.

As mentioned above, the method (400) includes monitoring (401) a social CRM system to determine modifications made to the business hierarchy of roles. In one example, modifications may be made to the business hierarchy of roles via a user device. For example, a user using the user device may make modifications to external applications associated with the social CRM system. The user may modify customer accounts, products, members, opportunities, or combinations thereof. Further, other methods and techniques may be used to make the modifications to the business hierarchy of roles.

FIG. 5 is a diagram of an example of a reassigning system, according to the principles described herein. The reassigning system (500) includes a receiving engine (502), an identifying engine (504), and a reassigning engine (506). In this example, the reassigning system (500) also includes a monitoring engine (508). The engines (502, 504, 506, 508) refer to a combination of hardware and program instructions to perform a designated function. Each of the engines (502, 504, 506, 508) may include a processor and memory. The program instructions are stored in the memory and cause the processor to execute the designated function of the engine.

The receiving engine (502) receives modifications, the modifications representing an adjustment to a business hierarchy of roles. As mentioned above, the modifications further include merging, splitting, changing a geography, reassigning, or combinations thereof of customer accounts associated with the business hierarchy of roles. Further, the modifications further include selling, discontinuing, consolidating, or combinations thereof of products associated with the business hierarchy of roles.

The identifying engine (504) identifies, in a social CRM system, an opportunity associated with the business hierarchy of roles. In one example, the opportunities represent a complex record structure in the social CRM system and each of the opportunities is associated with a number of fields of the metadata.

The reassigning engine (506) reassigns, based on the modifications, the opportunity associated with the business hierarchy of roles. In one example, the reassigning engine (506) reassigns, based on the modifications, the business hierarchy of roles associated with the opportunity by adding or deleting a member or a department from the business hierarchy of roles. In another example, the reassigning engine (506) reassigns, based on the modifications, the business hierarchy of roles associated with the opportunity further by reassigning members of applications associated with the business hierarchy of roles. In yet another example, the reassigning engine (506) reassigns, based on the modifications, the business hierarchy of roles associated with the opportunity further by reassigning features, permissions, or combinations thereof for the applications associated with the business hierarchy of roles.

The monitoring engine (508) monitors the social CRM system to determine modifications made to the business hierarchy of roles. In one example, the monitoring engine (508) monitors one social CRM system. In another example, the monitoring engine (508) monitors several social CRM systems.

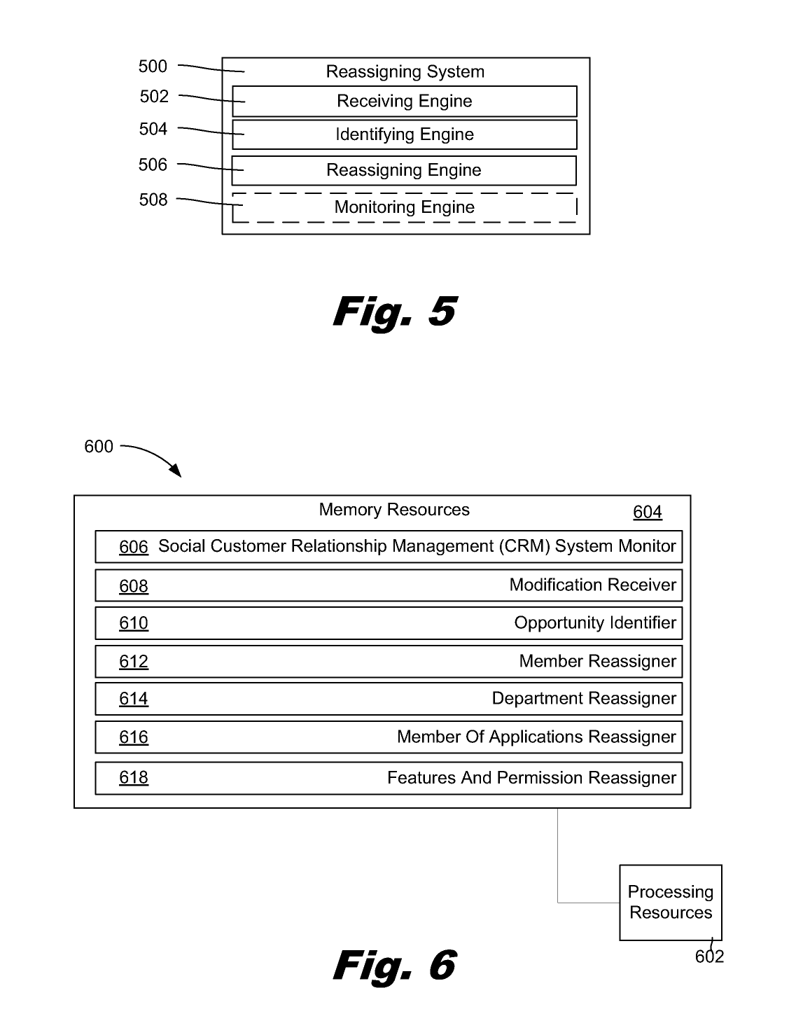

FIG. 6 is a diagram of an example of a reassigning system, according to the principles described herein. In this example, the reassigning system (600) includes processing resources (602) that are in communication with memory resources (604). Processing resources (602) include at least one processor and other resources used to process programmed instructions. The memory resources (604) represent generally any memory capable of storing data such as programmed instructions or data structures used by the reassigning system (600). The programmed instructions shown stored in the memory resources (604) include a social CRM system monitor (606), a modification receiver (608), an opportunity identifier (610), a member reassigner (612), a department reassigner (614), a member of applications reassigner (616), and a features and permission reassigner (618).

The memory resources (604) include a computer readable storage medium that contains computer readable program code to cause tasks to be executed by the processing resources (602). The computer readable storage medium may be tangible and/or physical storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, or types of memory, or combinations thereof.

The social CRM system monitor (606) represents programmed instructions that, when executed, cause the processing resources (602) to monitor a social CRM system to determine modifications made to the business hierarchy of roles. The modification receiver (608) represents programmed instructions that, when executed, cause the processing resources (602) to receive modifications, the modifications representing an adjustment to a business hierarchy of roles.

The opportunity identifier (610) represents programmed instructions that, when executed, cause the processing resources (602) to identify, in the social CRM system, an opportunity associated with the business hierarchy of roles. The member reassigner (612) represents programmed instructions that, when executed, cause the processing resources (602) to reassign, based on the modifications, the business hierarchy of roles associated with the opportunity by adding or deleting a member from the business hierarchy of roles.

The department reassigner (614) represents programmed instructions that, when executed, cause the processing resources (602) to reassign, based on the modifications, the business hierarchy of roles associated with the opportunity by adding or deleting a department from the business hierarchy of roles.

The member of applications reassigner (616) represents programmed instructions that, when executed, cause the processing resources (602) to reassign, based on the modifications, the business hierarchy of roles associated with the opportunity by reassigning members for applications associated with the business hierarchy of roles. The features and permission reassigner (618) represents programmed instructions that, when executed, cause the processing resources (602) to reassign, based on the modifications, the business hierarchy of roles associated with the opportunity by reassigning features, permissions, or combinations thereof for the applications associated with the business hierarchy of roles.

Further, the memory resources (604) may be part of an installation package. In response to installing the installation package, the programmed instructions of the memory resources (604) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (602) and the memory resources (604) are located within the same physical component, such as a server, or a network component. The memory resources (604) may be part of the physical component's main memory, caches, registers, non-volatile memory, or elsewhere in the physical component's memory hierarchy. Alternatively, the memory resources (604) may be in communication with the processing resources (602) over a network. Further, the data structures, such as the libraries, may be accessed from a remote location over a network connection while the programmed instructions are located locally. Thus, the reassigning system (600) may be implemented on a user device, on a server, on a collection of servers, or combinations thereof.

The reassigning system (600) of FIG. 6 may be part of a general purpose computer. However, in alternative examples, the reassigning system (600) is part of an application specific integrated circuit.

The preceding description has been presented to illustrate and describe examples of the principles described. This description is not intended to be exhaustive or to limit these principles to any precise form disclosed. Many modifications and variations are possible in light of the above teaching.

The flowchart and block diagrams in the figures illustrate the architecture, functionality, and operations of possible implementations of systems, methods, and computer program products. In this regard, each block in the flowchart or block diagrams may represent a module, segment, or portion of code, which has a number of executable instructions for implementing the specific logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration and combination of blocks in the block diagrams and/or flowchart illustration, can be implemented by special purpose hardware-based systems that perform the specified functions or acts, or combinations of special purpose hardware and computer instructions.

The terminology used herein is for the purpose of describing particular examples, and is not intended to be limiting. As used herein, the singular forms “a,” “an” and “the” are intended to include the plural forms as well, unless the context clearly indicated otherwise. It will be further understood that the terms “comprises” and/or “comprising” when used in the specification, specify the presence of stated features, integers, operations, elements, and/or components, but do not preclude the presence or addition of a number of other features, integers, operations, elements, components, and/or groups thereof.

1-7. (canceled)

8. A system for reassigning a business hierarchy of roles associated with an opportunity in a social customer relationship management (CRM) system, the system comprising:
a monitoring engine to monitor a social customer relationship management (CRM) system to determine modifications made to a business hierarchy of roles;
a receiving engine to receive the modifications, the modifications representing an adjustment to the business hierarchy of roles;
an identifying engine to identify, in the social CRM system, an opportunity associated with the business hierarchy of roles; and
a reassigning engine to reassign, based on the modifications, the opportunity associated with the business hierarchy of roles;
in which the reassigning engine reassigns, based on the modifications, the business hierarchy of roles associated with the opportunity by adding or deleting a member or a department from the business hierarchy of roles.

9. The system of claim 8, in which the reassigning engine reassigns, based on the modifications, the business hierarchy of roles associated with the opportunity by reassigning members of applications associated with the business hierarchy of roles.

10. The system of claim 8, in which the reassigning engine reassigns, based on the modifications, the business hierarchy of roles associated with the opportunity by reassigning features, permissions, or combinations thereof for the applications associated with the business hierarchy of roles.

11. The system of claim 8, in which the modifications further comprise merging, splitting, changing a geography, reassigning, or combinations thereof of customer accounts associated with the opportunity.

12. The system of claim 11, in which the modifications further comprises selling, discontinuing, consolidating, or combinations thereof of products associated with the opportunity.

13. The system of claim 8, in which the opportunity represents a complex record structure in the social CRM system and the opportunity is associated with a number of fields of the metadata.

14. A computer program product for reassigning a business hierarchy of roles associated with an opportunity in a social customer relationship management (CRM) system, comprising:
a tangible computer readable storage medium, said tangible computer readable storage medium comprising computer readable program code embodied therewith, said computer readable program code comprising program instructions that, when executed, causes a processor to:
monitor a social customer relationship management (CRM) system to determine modifications made to a business hierarchy of roles;
identify, in the social CRM system, an opportunity associated with the business hierarchy of roles; and
reassign, based on the modifications, the opportunity associated with the business hierarchy of roles;
in which the computer program product reassigns, based on the modifications, the business hierarchy of roles associated with the opportunity by adding or deleting a member or a department from the business hierarchy of roles.

15. The product of claim 14, further comprising computer readable program code comprising program instructions that, when executed, cause said processor to receive the modifications, the modifications representing an adjustment to the business hierarchy of roles.

16. The product of claim 14, further comprising computer readable program code comprising program instructions that, when executed, cause said processor to reassign members of applications associated with the business hierarchy of roles.

17. The product of claim 14, further comprising computer readable program code comprising program instructions that, when executed, cause said processor to reassign features, permissions, or combinations thereof for the applications associated with the business hierarchy of roles.

18. The product of claim 14, in which the modifications further comprise merging, splitting, changing a geography, reassigning, or combinations thereof of customer accounts associated with the opportunity.

19. The product of claim 18, in which the modifications further comprises selling, discontinuing, consolidating, or combinations thereof of products associated with the opportunity.

20. The product of claim 14, in which the opportunity represents a complex record structure in the social CRM system and the opportunity is associated with a number of fields of the metadata.
